(19) United States
(12) Patent Application Publication
(10) Pub. No.: US 2019/0084198 A1
(43) Pub. Date: Mar. 21, 2019

(54) METHOD FOR PATTERNING FOAM PAD

(71) Applicant: HUNG YA WANG, TAICHUNG CITY (TW)

(72) Inventor: HUNG YA WANG, TAICHUNG CITY (TW)

(21) Appl. No.: 15/708,571

(22) Filed: Sep. 19, 2017

(51) Int. Cl. B29C 43/40; B29C 43/00; B29C 43/14

(52) U.S. Cl. CPC B29C 43/40; B29K 2105/04; B29C 43/14; B29C 43/003

(57) ABSTRACT

A method for patterning a foam pad includes transversely cutting the foam pad so that the foam pad has a cut surface; covering the cut surface with a dye paper on which a predetermined pattern is formed using a dye, performing a first hot press process on the dye paper so that the dye on the dye paper is vaporized and transferred to the cut surface, and removing the dye paper; applying a transparent PU resin onto the cut surface that has been dyed, and curing the PU resin; and performing a second hot press process on the PU resin on the cut surface, so that the cut surface is increased in density and the PU resin encloses the dye, thereby making the dye firmly attached to the cut surface.

### BACKGROUND OF THE INVENTION

### 1. Technical Field

The present invention relates to manufacturing of foam pads, and more particularly to a method for patterning a foam pad.

### 2. Description of Related Art

FIG. 7 is a schematic drawing that illustrates a conventional method for patterning a foam pad. The known method involves transferring a pattern ink layer of a transfer film 91 onto a grained surface 90 of a foam pad 9 that has grains using a heated pressing roller 92, thereby forming a layer of decorative patterns 93.

However, the known method for making the pattern layer 93 on the grained surface 90 of the foam pad 9 has its defects. In addition to the fact that the necessary transfer film is expensive, since the plastic film forming the transfer film is stretchable, a predetermined graphic image may need several times of topping to be correctly colored, and this leads to great consumption of transfer films 91. Moreover, it is difficult to recycle the used plastic film of the transfer film 91 in an environmentally friendly way. Besides, it is a common practice to apply a release agent on the mold before the mode is used for the forming and molding of the foam pad 9 with the attempt to facilitate demolding. This release agent may undesirably transferred to the surface of the resulting foam pad 9, and have adverse effects to the subsequent transfer of the pattern layer 93, making the pattern layer 93 likely to peel off. Moreover, the pattern layer 93 on the foam pad 9 made by transfer only has a very small thickness of ink, and tend to get worn or damaged after frequent footsteps or impacts from rough objects, making the pattern layer 93 lose its integrity.

In order to address the defects of the conventional method for patterning foam pads, one try made by the inventor of the present invention is to cut a foam pad and transfer a pattern layer onto its cut surface. Since the cut surface has densely distributed open cells, the dye can easily permeate in and attach to the foam texture of the open cells, advantageously making the transferred pattern layer unlikely to peel off.

While the densely distributed open cells on the cut surface do contribute to the dye's easy permeation and attachment, and in turn the good coloring effect, the dye is simply attached to the foam texture of the open cells, without being enclosed and protected, so the pattern is still in high risk of bleeding and peeling off when being subject to attrition or external impacts, raising a need for further improving the method.

### BRIEF SUMMARY OF THE INVENTION

The primary objective of the present invention is to provide a method for patterning a foam pad, which effectively reduces the manufacturing cost, significantly improves attachment of the dye, and prevents the transferred pattern from bleeding, wear and scrap to maintain its integrity for long time.

For achieving the foregoing objective, the disclosed method for patterning a foam pad comprises the following steps:
a. transversely cutting the foam pad so that the foam pad has a cut surface;
b. covering the cut surface with a dye paper on which a predetermined pattern is formed using a dye, performing a first hot press process on the dye paper so that the dye on the dye paper is vaporized and transferred to the cut surface, and removing the dye paper;
c. applying a transparent PU resin onto the cut surface that has been dyed, and curing the PU resin; and
d. performing a second hot press process on the PU resin on the cut surface, so that the cut surface is increased in density and the PU resin encloses the dye.

Preferably, the first hot press process may involve pressing the dye paper against the cut surface using a preheated roller or a compression mold.

Preferably, the second hot press process may involve pressing the PU resin using a preheated roller or a compression mold.

Furthermore, the roller or the compression mold has its surface embossed with anti-slip grains, so that by performing the second hot press process, a surface having anti-slip grains is formed on the PU resin.

### BRIEF DESCRIPTION OF THE SEVERAL VIEWS OF THE DRAWINGS

FIG. 1 is a flowchart of the present invention.

FIG. 2 shows how the method of the present invention patterns a foam pad.

FIG. 3 illustrates a compression mold performing a first hot press process according to the present invention.

FIG. 4 is an enlarged, cross-sectional view of the foam pad with its dyed cut surface covered by PU resin.

FIG. 5 is an enlarged, cross-sectional view of the foam pad after a second hot press process.

FIG. 6 illustrates a roller performing a second hot press process according to the present invention.

FIG. 7 is a schematic drawing that illustrates a conventional method for patterning a foam pad.

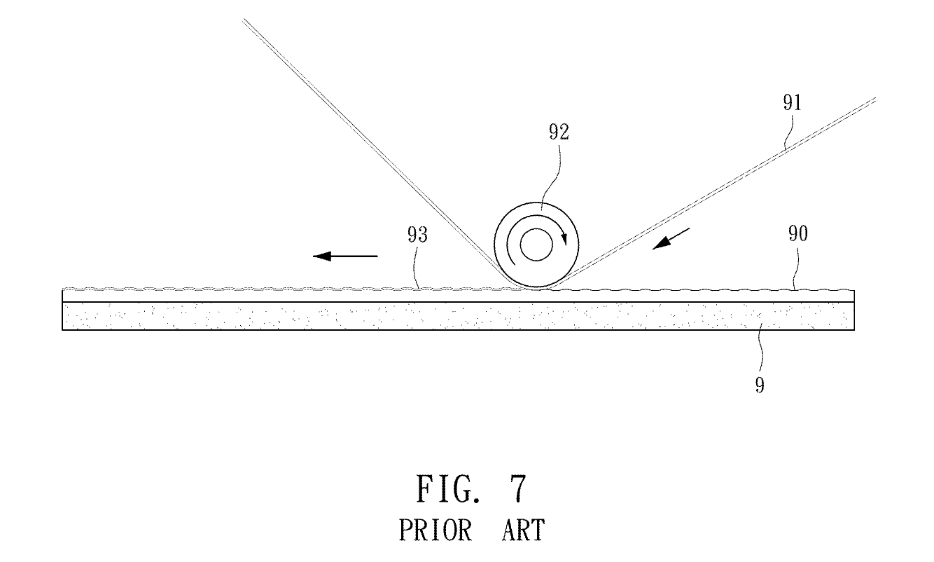

### DETAILED DESCRIPTION OF THE INVENTION

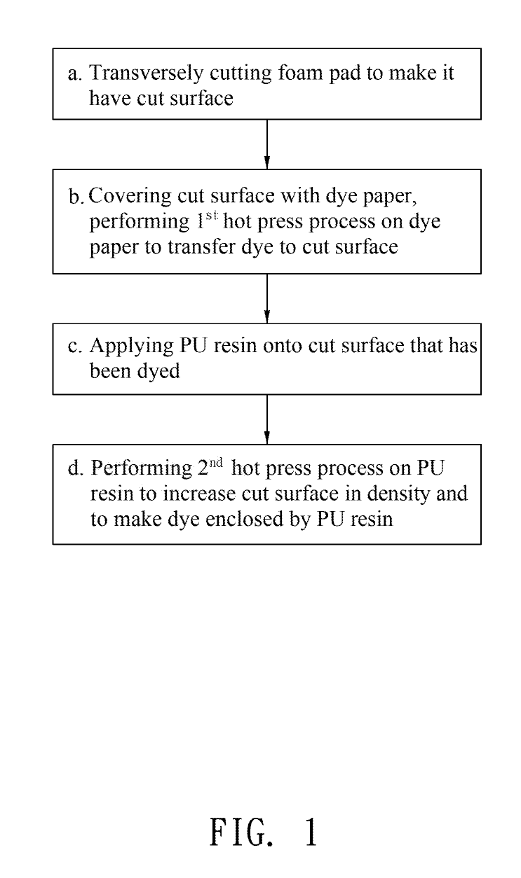

Referring to FIGS. 1˜5, a method for patterning a foam pad according to the present invention primarily comprises the following steps:

In a first step, or Step a, a foam pad 1 is prepared. The foam pad 1 is made by foaming a foamable material in a mold (not shown). In the present embodiment, the foam pad 1 is made of ethylene vinyl acetate (EVA). During the foaming process of the foam pad 1, since the mold has its upper surface and lower surface formed with grains, the foam pad 1 is such molded that its upper and lower surfaces 11 are grained by the grains of the mold. The grained surfaces 11 usually have their density higher than the interior of the foam pad 1. Now referring to FIG, 2, the foamed and molded foam pad 1 is transversely cut into several segments. Particularly, the foam pad 1 may be evenly, transversely cut into two segments. Alternatively, the foam pad 1 may be transversely cut into more segments, depending on its thickness, so that the surface where the cutting is performed (i.e. the surface reverse to the grained surface 11) forms a cut surface 12. This cut surface 12 is made between the upper and lower surface of the foam pad 1, and since the interior of the foam pad 1 has lower density, the cut surface 12 is presented with a plurality of open cells 13.

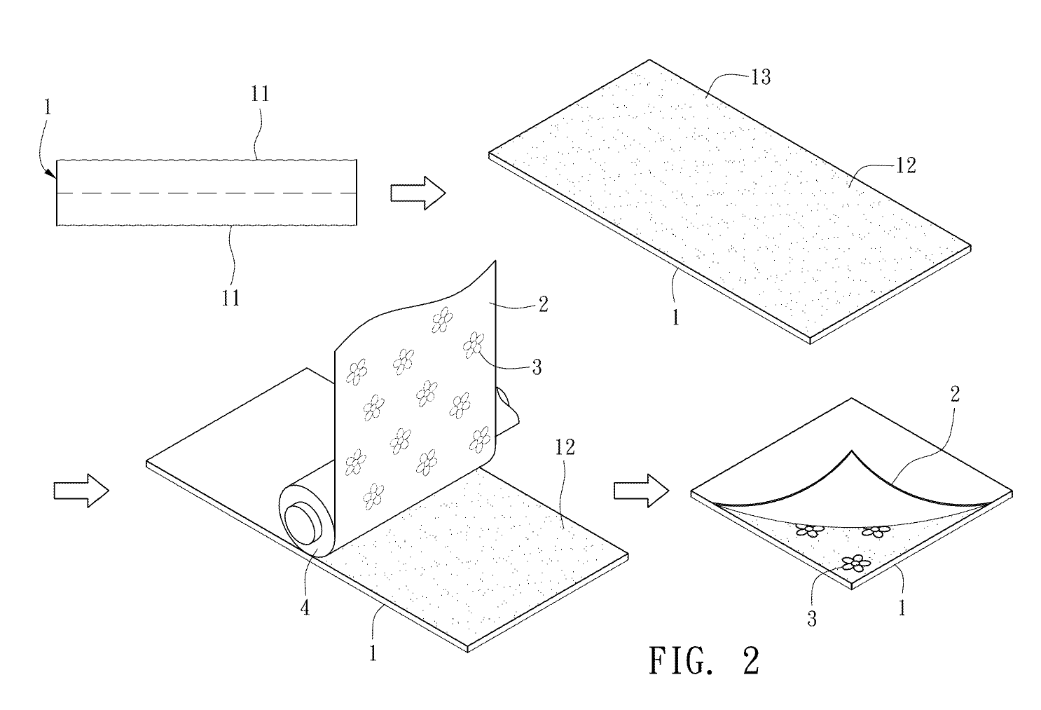

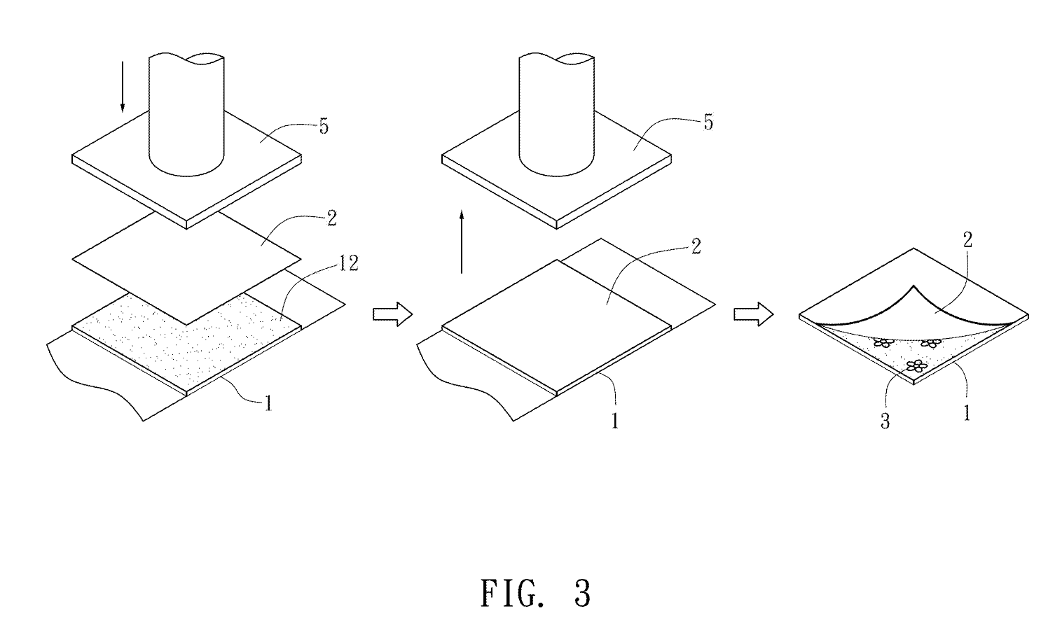

In a second step, or Step b, a dye paper 2 is laid on the cut surface 12 of the foam pad 1. The dye paper 2 is provided with a predetermined pattern 3 using a dye 21. Then a first hot press process is applied to the dye paper 2, so as to heat and vaporize the dye 21 of the dye paper 2, thereby transferring it onto the cut surface 12. During this process, the dye 21 permeates into open cells 13 of the cut surface 12 and attaches to the cut surface 12, thereby making the cut surface 12 have the predetermined pattern 3 formed by the dye 21. After the transfer, the dye paper 2 is removed. In the present embodiment, as shown in FIG. 2, the first hot press process involves pressing the dye paper 2 against the foam pad 1 using a preheated roller 4, so that the dye 21 on the dye paper 2 is vaporized and transferred onto the cut surface 12 of the foam pad 1, thereby forming the predetermined pattern 3. Alternatively, as shown in FIG. 3, a preheated compression mold 5 is used to press the dye paper against the foam pad 1, so that the dye 21 is transferred onto the cut surface 12 of the foam pad 1, thereby forming the predetermined pattern 3.

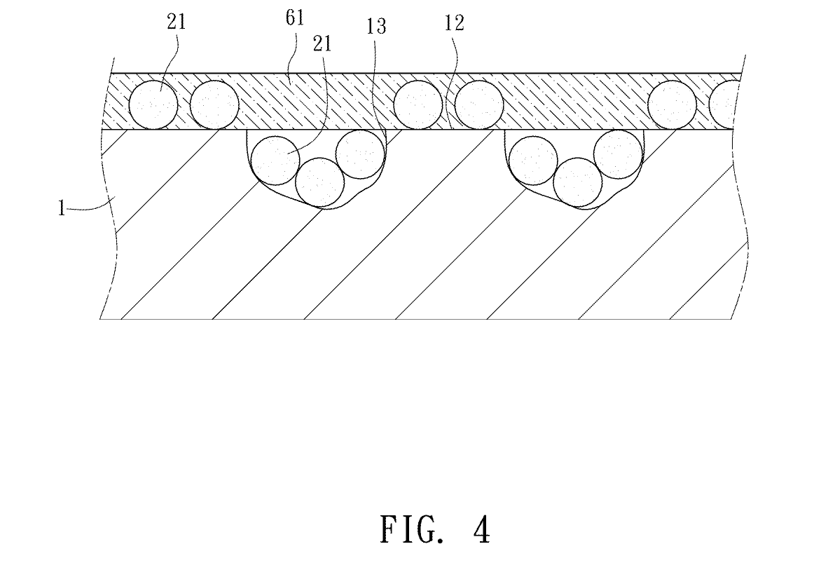

In a third step, or Step c, as shown in FIG. 4, a transparent PU resin 61 is applied to the cut surface 12 having the dye 21 transferred thereon, and hot baking is used to cure the PU resin 61.

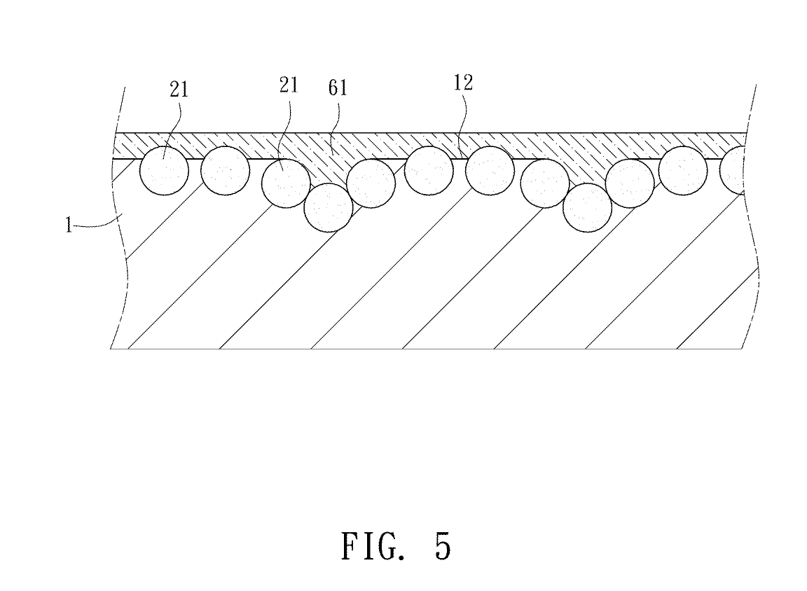

The last is a fourth step, or Step d, as shown in FIG. 5. Therein, a second hot press process is performed on the PU resin 61 covering the cut surface 12. In the present embodiment, the second hot press process may also be performed on the PU resin 61 using the preheated roller or compression mold (not shown). The second hot press process makes the open cells 13 on the cut surface 12 shrunk and closed, thereby increasing the density at the cut surface 12 while making the PU resin 61 become melted and fully permeate into the foam texture of the open cells 13 to enclose the dye 21. In this manner, the dye 21 that has been transferred to the cut surface 12 using the disclosed method can be secured on the cut surface 12 firmly because of compression of the open cells 13 and enclosure of the PU resin 61. Additionally, the PU resin 61, after cured, can provide further isolation and protection, thereby preventing the predetermined pattern 3 formed by the dye 21 attached to the cut surface 12 from bleeding, wear and scrap, and maintaining integrity of the transferred pattern for long time.

The method for patterning foam pads of the present invention has the following benefits as compared to the conventional film transfer process:

1. Since the dye paper 2 is made by printing the dye 21 on a paper film, which hardly stretches and is favorable to printing and topping, yet is inexpensive, the manufacturing cost can be reduced. Besides, after transfer, the used paper film can be recycled for reuse, making the disclosed method environmentally friendly.

2. The cut surface 12 of the foam pad 1 has no release agents, but only densely distributed open cells 13, so the dye 21 can easily permeate into the cut surface 12 and attach to the foam texture of the open cells 13. After application of the PU resin and the second hot press process, the open cells 13 on the cut surface 12 are shrunk to make the cut surface 12 denser, and the melt PU resin 61 permeates into the foam texture of the open cells 13 to enclose the dye 21, further securing the dye 21 onto the cut surface 12.

3. After cured, the PU resin 61 can provide further isolation and protection, thereby preventing the predetermined pattern 3 formed by the dye 21 attached to the cut surface 12 from bleeding, wear and scrap, and maintaining integrity of the transferred pattern for long time.

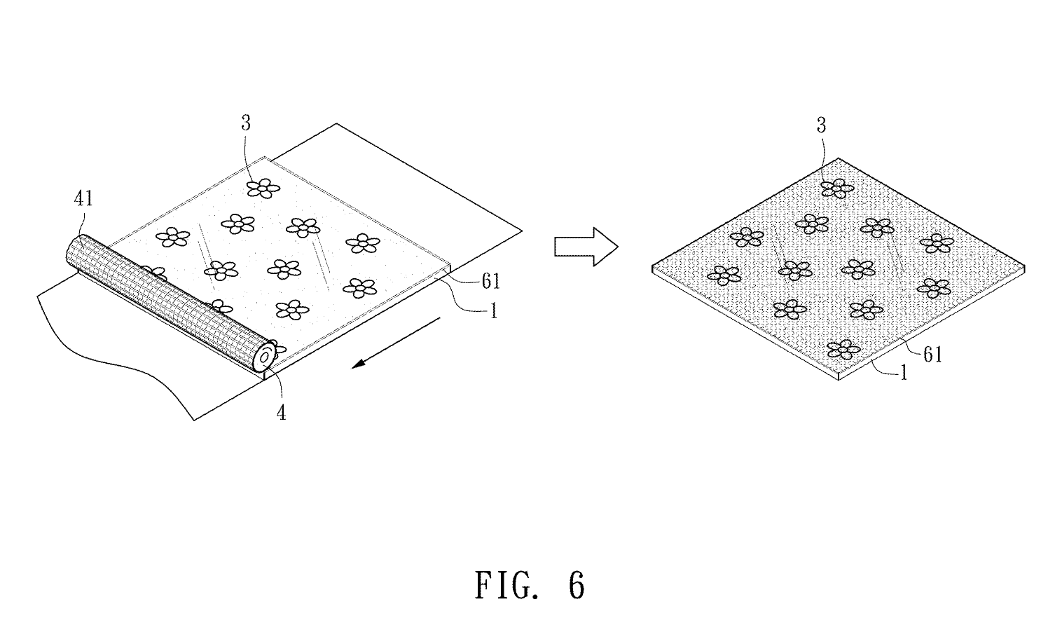

Of course, there are still many other examples of the present invention with merely differences in details therebetween. FIG. 6 provides a second embodiment of the present invention, which is different form the foregoing embodiment in that the second hot press process is performed by using a preheated roller 4 to press the PU resin 61, wherein the roller 4 has its surface embossed with anti-slip grains 41, so that as the second hot press process is performed, a surface with anti-slip grains is formed on the PU resin 61, for both esthetic and anti-slip effects. Alternatively, in the second embodiment, the second hot press process may be performed to press the PU resin 61 using a preheated compression mold (not shown), wherein the compression mold also has its surface embossed with anti-slip grains, thereby similarly forming a surface with anti-slip grains on the PU resin 61 during the second hot press process.

What is claimed is:

1. A method for patterning a foam pad comprising steps of:
a. transversely cutting the foam pad so that the foam pad has a cut surface;
b. covering the cut surface with a dye paper on which a predetermined pattern is formed using a dye, performing a first hot press process on the dye paper so that the dye on the dye paper is vaporized and transferred to the cut surface, and removing the dye paper;
c. applying a transparent PU resin onto the cut surface that has been dyed, and curing the PU resin; and
d. performing a second hot press process on the PU resin on the cut surface, so that the cut surface is increased in density and the PU resin encloses the dye.

2. The method of claim 1, wherein the first hot press process involves pressing the dye paper against the cut surface using a preheated roller.

3. The method of claim 1, wherein the first hot press process involves pressing the dye paper against the cut surface using a preheated compression mold.

4. The method of claim 1, wherein the second hot press process involves pressing the PU resin using a preheated roller.

5. The method of claim 4, wherein the roller has its surface embossed with anti-slip grains, so that by performing the second hot press process, a surface having anti-slip grains is formed on the PU resin.

6. The method of claim 1, wherein the second hot press process involves pressing the PU resin using a preheated compression mold.

7. The method of claim 6, wherein the compression mold has its surface embossed with anti-slip grains, so that by performing the second hot press process, a surface having anti-slip grains is foamed on the PU resin.
